(19) United States
(12) Patent Application Publication
(10) Pub. No.: US 2025/0344643 A1
(43) Pub. Date: Nov. 13, 2025

(54) Clutch Assembly

(71) Applicant: Ortlinghaus-Werke GmbH, Wermelskirchen (DE)

(72) Inventor: Jörg SORHAGE, Bad Oeynhausen (DE)

(21) Appl. No.: 19/200,905

(22) Filed: May 7, 2025

(30) Foreign Application Priority Data
May 8, 2024 (EP) 24174754.2

(51) Int. Cl. A01F 15/08; A01F 15/04

(52) U.S. Cl. CPC A01F 15/0841; A01F 15/042

(57) ABSTRACT

A clutch assembly for a drive train is equipped with a flywheel in a baler, with a slip clutch connected upstream of the flywheel on the drive side. The slip clutch is designed to be switchable and that a further clutch is provided which is connected downstream of the flywheel on the drive side, wherein the further clutch is an overload clutch and is combined with a brake to form a clutch-brake combination.

### CROSS-REFERENCE TO RELATED APPLICATION

This application claims the benefit of European Application No. 24174754.2, filed on May 8, 2024. The entire disclosure of the application referenced above is incorporated herein by reference.

### FIELD

The disclosure relates to a clutch assembly for a drive train equipped with a flywheel in a baler, the clutch assembly comprising a slip clutch connected upstream of the flywheel on the drive side. The disclosure also relates to a baler, preferably a square baler, with a working assembly for processing crop into bales and a drive train for driving the working assembly.

### BACKGROUND

Balers in general and clutch assemblies for balers in particular are well known from prior art, for which reason no separate written reference is required here. Reference is therefore made only by way of example to EP 3 400 786 B2, which relates to a baler of the type known in the art.

A generic baler is used, for example, to pick up stalk-like crops such as straw, hay, grass, and/or the like deposited in swaths and to press them into bales, in particular into square bales. For this purpose, a generic baler has a working assembly for processing crop into bales and a drive train which when used as intended serves to drive the working assembly. The working assembly can provide a plurality of individual working devices, in particular a press piston mounted in a press chamber so as to be movable in a translational manner. When used as intended, this serves to press the collected crop into bales of the desired size and density.

A tractor or an output of a power take-off shaft provided by the tractor is typically used to apply force to the drive train, the drive train of the baler being connected to the output of the power take-off shaft when used as intended. In this case, i.e. when used as intended, there is a drive connection between the tractor's power take-off shaft on the one hand and the drive train on the baler side on the other.

The drive train is used in a manner known per se to drive the working assembly on the baler side. As already described, this provides, among other things, a press chamber in which a press piston is mounted so that it can move in a translational manner. During pressing, the press piston is set into an oscillating motion by means of the drive train, as a result of which the crop previously introduced into the press chamber is pressed into bales.

In order to be able to apply a sufficiently large pressing force during the pressing operation and to protect the output of the power take-off shaft of the tractor from unwanted load peaks, the drive train of the baler is equipped with a flywheel that serves as an energy storage. Depending on the size of the baler, such a flywheel can have a mass of several 100 kg and therefore has a correspondingly high moment of inertia.

However, a high moment of inertia with regard to the flywheel has the disadvantage, particularly when starting the baler from a standstill, that the drive provided by the tractor can be overloaded and/or the start-up process takes a relatively long time, as the drive train on the baler side can only be set in motion very slowly.

An initial measure to protect the tractor drive in particular is a slip clutch connected upstream of the flywheel on the drive side. This ensures that in the event of an overload, the drive train and the power take-off shaft are decoupled due to slippage.

However, this pre-known protective measure alone is not sufficient and is also not suitable for improving the start-up process of the baler. This is all the more true in view of the fact that even during normal operation of the baler, it may be necessary to decelerate and/or re-accelerate the working assembly on the baler side and thus also the drive train which is in drive connection with the working assembly.

To counteract these problems, the aforementioned EP 3 400 786 B2 proposes a flywheel with mass elements that are displaceable in position and that can be actuated so that the moment of inertia of the flywheel can be varied. The moment of inertia of the flywheel can therefore be varied, i.e. changed, during operation and/or when the baler is at a standstill.

This solution, which is known from EP 3 400 786 B2, is technically very complex, prone to wear and maintenance-intensive. It also has the disadvantage of a slow response, since a change in the moment of inertia requires a corresponding change in the position of the individual mass elements.

In contrast to EP 3 400 786 B2, a completely different approach uses an additional motor as an auxiliary drive for the flywheel. During start-up, this additional motor accelerates the flywheel before the drive on the tractor side is connected. This solution is disadvantageous in that it requires a communication link between the tractor and the baler or the additional motor must be switched manually, which can lead to unwanted operating errors.

According to another known design, a power shift transmission is used that is connected upstream of the flywheel on the drive side. The power shift transmission is therefore provided between the drive on the tractor side on the one hand and the flywheel on the other. It enables a slow increase in the rotational speed which acts on the flywheel, especially during start-up. The power shift transmission therefore makes it possible to increase the output rotational speed compared to the input rotational speed. The disadvantage of this well-known solution is that it is technically complex and therefore expensive.

According to another design known from prior art, a centrifugal clutch is connected upstream of the flywheel on the drive side as an additional clutch. A slip clutch on the one hand and a centrifugal clutch on the other are therefore provided in series. In this case, the slip clutch ensures in a manner known per se that no impermissibly high torque is transmitted from the tractor to the baler. The task of the centrifugal clutch, however, is to close during operation and to accelerate the flywheel. The centrifugal clutch hence takes over the acceleration work. This design is also relatively complex, subject to wear, and maintenance-intensive.

The known solutions therefore have in common that a slip clutch and an auxiliary drive are provided, wherein the auxiliary drive can be an additional motor, a power shift transmission, or a centrifugal clutch and serves to achieve the acceleration of the flywheel. Each of the known auxiliary drives has its own specific disadvantages. For example, an additional motor makes automation complex because it requires a separate communication link between the tractor and the baler. Alternatively, manual intervention is possible, but this is prone to errors and, especially in the event of an overload, its effectiveness depends on the reaction of the person operating the tractor. The power shift transmission is also complex and requires an additional overload clutch and a safety system downstream of the flywheel. A centrifugal clutch as an auxiliary drive is very large, heavy, and maintenance-intensive, so that it can only be used economically for very specific tasks.

Based on the above, it is an object of the disclosure to propose a clutch assembly the design of which is improved in such a way that safe operation of a baler is possible with a simple design.

### SUMMARY

To achieve this object, the disclosure proposes a clutch assembly which is characterized by the fact that the slip clutch is designed to be switchable and that a further clutch is provided which is connected downstream of the flywheel on the drive side, said further clutch being an overload clutch and being combined with a brake to form a clutch-brake combination.

The clutch assembly according to the disclosure has two clutches, namely a slip clutch connected upstream of the flywheel on the drive side and a further clutch connected downstream of the flywheel on the drive side. The flywheel is therefore arranged between the slip clutch on the one hand and the further clutch on the other.

The slip clutch is the slip clutch already provided in prior art and serves to ensure that no impermissibly high torque is transmitted from the tractor to the baler during normal use. In contrast to prior art, however, the slip clutch according to the disclosure is designed to be switchable. It is therefore possible to smoothly connect the flywheel when the tractor-side output f is already rotating. This connection can be carried out automatically in a simple manner so that no manual intervention by a tractor operator is required.

The slip clutch designed as a switchable clutch therefore performs three tasks in the clutch assembly according to the disclosure. On the one hand, it provides protection against overload, in particular against an impermissibly high drive torque. Secondly, it serves to accelerate the flywheel, namely in particular by its smooth connection in the intended use. In addition, in the case of an overload, for example, due to malfunction, it enables the engine power on the tractor side to be automatically disconnected from the press, and this without manual intervention by an operator.

The additional clutch provided by the disclosure is designed as an overload clutch and combined with a brake to form a clutch-brake combination. This clutch-brake combination is connected downstream of the flywheel and essentially performs two tasks.

On the one hand, the output of the baler is protected from the kinetic energy of the flywheel. Force decoupling of the flywheel and the working assembly can take place, so that in the case of a malfunction, for example, overload and possible destruction of the working assembly are reliably prevented. On the other hand, the brake allows targeted stopping.

In the case of an overload, the additional clutch, which is designed as an overload clutch, can slip, thereby providing the protective function described above. Furthermore, due to the combination of clutch and brake according to the disclosure, the clutch can be opened while simultaneously closing the brake. When the clutch is opened, the output is set load-free towards the working assembly and stopped in a targeted manner by means of the brake. In this context, it is particularly advantageous that automatic switching of the clutch-brake combination can be easily achieved by means of a control on the baler side. This offers better protection against overload and no intervention on the tractor and/or operator side is required. Switching on and off, i.e. switching the slip clutch, can also be carried out by means of the control on the press side, which control enables fully automated operation and eliminates the need for a communication link between the tractor and the baler.

According to a further feature of the disclosure, the further clutch, i.e. the clutch of the clutch-brake combination, is a slip clutch. This can slip in the case of overload and thus protect the output of the baler from flywheel-induced overload. The further clutch is preferably hydraulically operated and, when used as intended, transmits the power of the flywheel and the power of the tractor-side drive to the output shaft of the clutch-brake combination, i.e. to the working assembly. The combination of clutch and brake results in an overall compact design.

According to a further feature of the disclosure, it is provided that both the switchable slip clutch and the clutch-brake combination are designed to be hydraulically switchable. With regard to the clutch-brake combination, it is provided that the brake is spring-actuated and the clutch is hydraulically actuated. When the clutch is open, the brake is closed so that the drive train is disconnected from the load on the side of the working assembly and braked at the same time.

The hydraulically switchable slip clutch has the particular advantage that control on the baler side is possible, meaning that neither manual intervention nor control from the tractor side is necessary. Furthermore, no additional auxiliary drive is required for the flywheel, because it can be accelerated by switching the slip clutch when the tractor rotational speed is applied at the output of the power take-off shaft.

According to a further feature of the disclosure, it is provided that a gearbox is connected downstream of the clutch-brake combination on the drive side. A gearbox is therefore provided on the output side of the clutch-brake combination, which is in drive connection with the actual working assembly. In the intended use, torque is therefore transmitted from the flywheel to the output shaft, namely under the interposition of the clutch-brake combination. The output shaft is in turn connected to the gearbox, which for its part is connected to the working assembly. When the clutch-brake combination is open, the output shaft is set load-free and is slowed down. The gearbox downstream of the clutch-brake combination, including the downstream working assembly, is thus protected against overload.

According to a further feature of the disclosure, it is provided that the flywheel and the clutch-brake combination and preferably also the gearbox form a common structural unit. This provides an overall compact design, which is advantageous. If necessary, this also allows existing balers to be retrofitted.

According to a further feature of the disclosure, it is provided that an input gearbox is connected upstream or downstream of the switchable slip clutch on the drive side. Such an input gearbox preferably translates into the faster gear, which allows the flywheel to be designed smaller. This is particularly advantageous when the flywheel is combined with the clutch-brake combination and the gearbox to form a common structural unit.

According to a further feature of the disclosure, it is provided that the clutch-brake combination is designed to transmit a torque of 7000 Nm to 8000 Nm, preferably 7500 Nm. This ensures that the baler operates as intended, in particular that the harvested material is compressed as desired into sufficiently compact bales. A sufficiently compact shape of the bales is preferred, in particular for transport reasons.

According to a further feature of the disclosure, it is provided that the switchable slip clutch is configured to slip at an overload of 2200 Nm to 3000 Nm, preferably 2600 Nm. The slip clutch is thermally designed in such a way that the flywheel can be accelerated when used as intended, especially during start-up as intended. However, the slip clutch must slip as intended if the torque applied on the tractor side is too high, so that the drive train on the baler side is protected against overload. The drive train and its components are designed so that an overload only occurs when the torque applied to the tractor exceeds 3000 Nm.

The disclosure also proposes a baler, in particular a square baler, with a working assembly for processing crop into bales and a drive train for driving the working assembly, wherein the baler is characterized in that the drive train has a clutch assembly of the type described above, i.e. of the type according to the disclosure. A baler equipped in this way has the advantages already described above.

The working assembly can provide a variety of different working devices, for example a pick-up, a cutting rotor, a feed rake, and/or a knotter. In any case, however, the working assembly according to the disclosure provides a press piston mounted in a press chamber so that it can move in a translational manner. This serves to actually press the harvested material. In the intended use, the press piston is driven via the drive train with the clutch assembly according to the disclosure interposed. Due to the design of the disclosure, the transmission of overload peaks to the tractor drive is prevented just as reliably as overload operation of the press piston, in particular due to the kinetic energy released by the flywheel.

### BRIEF DESCRIPTION OF THE DRAWINGS

Further features and advantages of the disclosure are apparent from the following description with reference to the drawing figures.

FIG. 1 shows a purely schematic representation of the clutch assembly according to the disclosure;

FIG. 2 shows a further purely schematic representation of the clutch assembly according to the disclosure;

FIG. 3 shows a partially sectioned detailed view of a clutch-brake combination of the clutch assembly according to the disclosure, and

FIG. 4 shows a schematic perspective view of the clutch-brake combination according to FIG. 3.

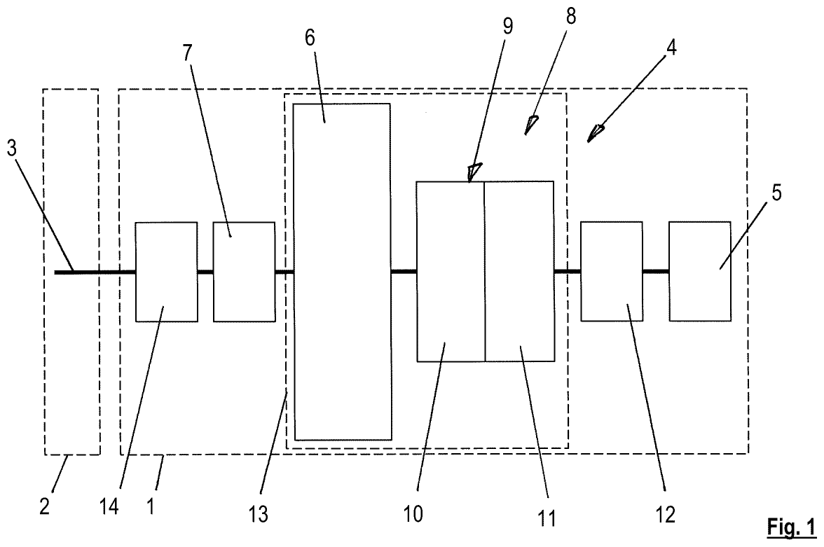

FIG. 1 shows a purely schematic representation of a clutch assembly 8 according to the disclosure. As will be explained in more detail below, this has a switchable slip clutch 7 on the one hand and a clutch-brake combination 9 on the other.

### DETAILED DESCRIPTION

The clutch assembly 8 according to the disclosure is part of a baler 1. The baler 1 serves in a manner known per se to compress in particular stalk-like crops such as straw, hay, and/or grass into bales. In its intended use, the baler 1 is pulled by a tractor 2 and is connected to it by a drive for operating a working assembly 5 provided by the baler 1. For this purpose, the baler 1 has a drive train 4 which when used as intended connects the working assembly 5 to a tractor-side power take-off shaft output 3.

The working assembly 5 provides a press piston mounted in a press chamber so that it can move in a translational manner. Crop fed into the press chamber can thus be compressed into bales as desired.

The drive train 4 is equipped with a flywheel 6. This design, which is known from prior art, serves in particular to generate sufficient pressing force by means of the press piston during pressing as intended.

The flywheel 6 is connected upstream of the slip clutch 7 on the drive side, which slip clutch is designed to be switchable. The slip clutch 7 is preferably hydraulically switchable.

A further clutch 10 is connected downstream of the flywheel 6 on the drive side. This is designed as an overload clutch, for example in the form of a slip clutch. This further clutch 10 is combined with a brake 11 to form a clutch-brake combination 9. The additional clutch 10 is hydraulically switchable and the brake 11 is spring-actuated. The slip clutch upstream of the flywheel 6 together with the clutch-brake combination 9 downstream of the flywheel 6 forms the clutch assembly 8 according to the disclosure.

In the embodiment shown, two additional gearboxes are provided, namely a gearbox 12, also referred to as the main gearbox, and an input gearbox 14. In the embodiment shown, the input gearbox 14 is connected upstream of the slip clutch 7. Alternatively, it would also be possible to arrange the input gearbox 14 between the slip clutch 7 and the flywheel 6.

The gearbox 12 is provided on the output side of the clutch-brake combination 9, where it is connected upstream of the working assembly 5.

According to a particularly preferred embodiment of the disclosure, the flywheel 6, the clutch-brake combination 9, and the gearbox 12 form a common structural unit 13. Alternatively, only the flywheel 6 and the clutch-brake combination 9 are combined to form a common structural unit 13, as shown in FIG. 1.

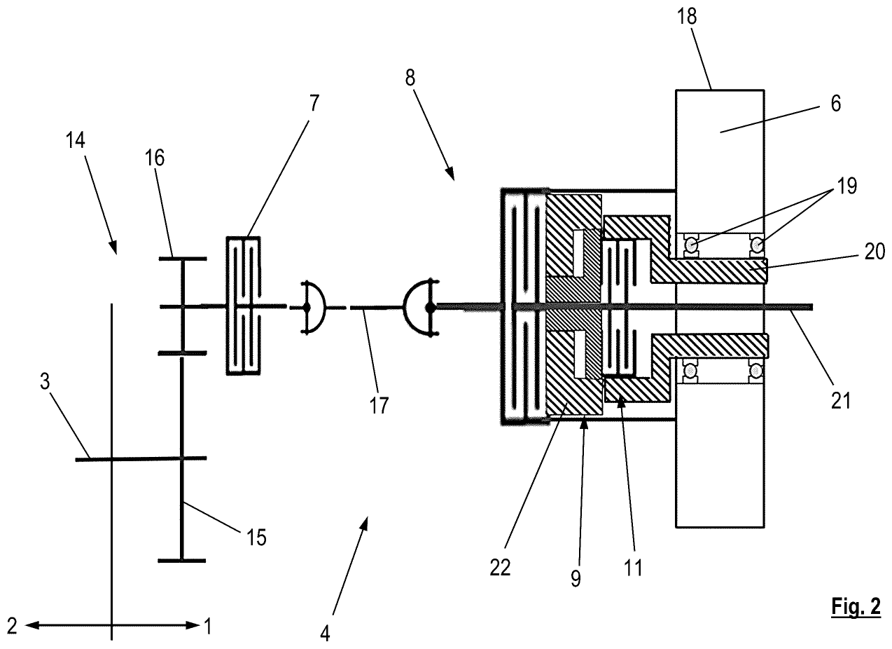

FIG. 2 shows another schematic representation of the clutch assembly 8 according to the disclosure.

As can be seen from this representation, the input gear 14 upstream of the slip clutch 7 has two gear wheels Z₁ 15 and Z₂ 16, wherein a transmission into the faster gear takes place. This advantageously allows a smaller flywheel 6 to be used.

A cardan shaft 17 is interposed between the slip clutch 7 and the flywheel 6. This serves to compensate for any angular misalignment between the input gearbox 14 and the drive input of the flywheel 6.

A pot 18 is interposed between the cardan shaft 17 and the flywheel 6 and serves as a housing for the clutch-brake combination 9. This results in a particularly compact design.

The clutch-brake combination 9 comprises said further clutch 10 and the brake 11 that are coupled to each other via a common hydraulic switching device 22. The brake 11 is enclosed by a housing 20 which, with the interposition of corresponding bearings 19, rotatably accommodates the flywheel 6. The clutch-brake combination 9 is operatively connected to an output shaft 21 that is connected to the gearbox 12 in the final assembled state.

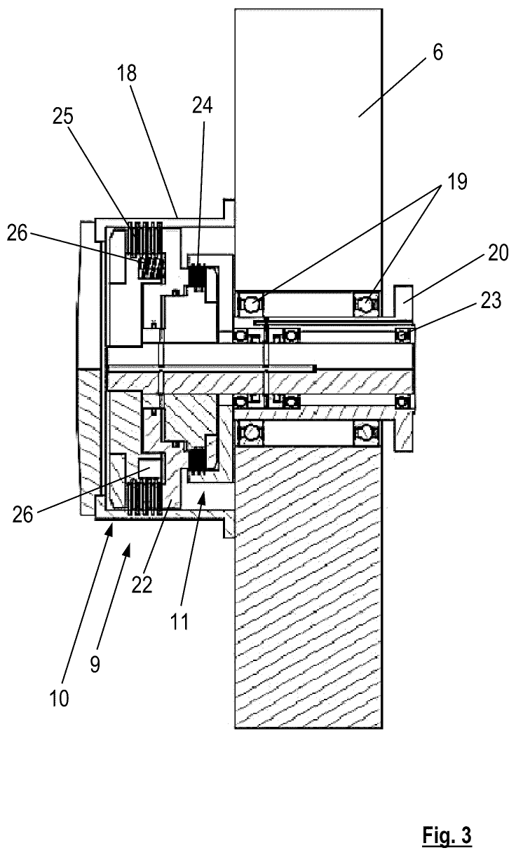

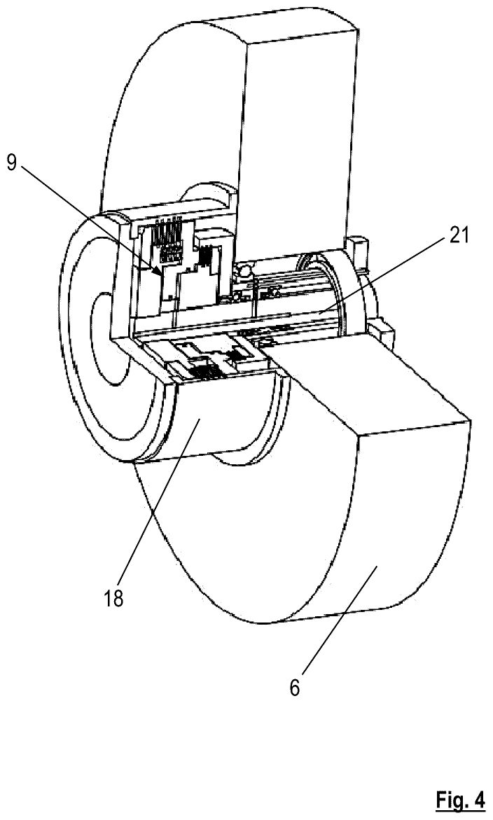

FIGS. 3 and 4 show the structure of the clutch-brake combination 9 in more detail. As can be seen from these illustrations, corresponding bearings 23 are provided for the rotatable mounting of the output shaft 21, the bearings supporting the output shaft 21 relative to the housing 20. This housing 20 also supports the flywheel 6 in the manner already described.

The clutch 10 and the brake 11 of the clutch-brake combination 9 have corresponding disc packs 24 and 25, with the hydraulic switching device 22 arranged between them. This is spring-biased by corresponding springs 26. In the event of hydraulic actuation, the switching device 22 is moved to the left with reference to the drawing plane according to FIG. 3 against the spring force acting on it, as a result of which the clutch 10 engages and the brake 11 opens. In this respect, the brake 11 is spring-actuated and the clutch 10 is hydraulically actuated.

As can be seen from a combined view of FIGS. 1 to 4, in the operation as intended, drive power is transmitted from a motor of the tractor 2 to the working assembly 5 of the baler 1 via the drive train 4. The switchable slip clutch 7 of the clutch assembly 8 according to the disclosure essentially performs three tasks, namely as follows:
Protection against overload, i.e., ensuring that no impermissibly high torque is transmitted from the tractor 2 to the baling press 1.
Acceleration of the flywheel 6, in particular by smoothly engaging the slip clutch 7 when torque is applied from the tractor side.
In the event of an overload of the working assembly 5, for example in the event of a malfunction, the tractor engine power is automatically switched off, i.e. interrupted, without the need for manual intervention by a user.

The switchable slip clutch 7 is connected upstream of the flywheel 6 on the drive side. The clutch-brake combination 9 belonging to the clutch assembly 8 according to the disclosure is connected downstream of the flywheel 6 on the drive side. The clutch-brake combination 9 essentially has two tasks, as follows:
The output on the clutch-brake combination side is protected against excessive kinetic energy of the flywheel 6, i.e., in the event of an overload, the clutch 10 of the clutch-brake combination 9 can slip, so that unintentional overloading of the working assembly 5 is prevented.
In the event of an overload, the clutch 10 not only slips. The clutch-brake combination 9 provided according to the disclosure rather enables the clutch 10 to be opened hydraulically, which relieves the load on the output, while simultaneously closing the brake 11, whereby a controlled stop of the drive train 4 is achieved.

The clutch-brake combination 9 can be equipped with appropriate sensors to detect slippage of the clutch 10. These are connected to a control system on the press side so that automatic operation of the clutch-brake combination 9 is possible. If the clutch 10 is detected to be slipping, the baler 1 can control the automatic opening of the clutch 10 while simultaneously closing the brake 11.

The control on the press side can also be used to switch the slip clutch 7, i.e., to switch the press 1 on and off. An additional communication link between the press 1 and the tractor 2 is therefore not necessary. Automatic operation of the press 1 is also possible, i.e., manual operation by a user is not necessary, which is particularly advantageous for safety reasons.

1. A clutch assembly for a drive train equipped with a flywheel in a baler, with a slip clutch connected upstream of the flywheel on the drive side, wherein the slip clutch is designed to be switchable and that a further clutch is provided which is connected downstream of the flywheel on the drive side, wherein the further clutch is an overload clutch and is combined with a brake to form a clutch-brake combination.

2. The clutch assembly according to claim 1, wherein the further clutch is a slip clutch.

3. The clutch assembly according to claim 1, wherein the switchable slip clutch and the clutch-brake combination are each hydraulically switchable.

4. The clutch assembly according to claim 1, wherein a gearbox is connected downstream of the clutch-brake combination.

5. The clutch assembly according to claim 4, wherein the flywheel and the clutch-brake combination and preferably also the gearbox form a common structural unit.

6. The clutch assembly according to claim 1, wherein the switchable slip clutch is connected upstream or downstream of an input gearbox on the drive side.

7. The clutch assembly according to claim 1, wherein the clutch-brake combination is configured to transmit a torque of 7000 Nm to 8000 Nm, preferably 7500 Nm.

8. The clutch assembly according to claim 1, wherein the switchable slip clutch is designed to slip at an overload of 2200 Nm to 3000 Nm, preferably 2600 Nm.

9. A baler with a working assembly for processing crop into bales and a drive train for driving the working assembly, wherein the drive train has a clutch assembly according to claim 1.

10. The baler according to claim 9, wherein the working assembly provides a press piston mounted in a press chamber so as to be movable in a translational manner.
